(19) United States
(12) Patent Application Publication
(10) Pub. No.: US 2006/0197862 A1
(43) Pub. Date: Sep. 7, 2006

(54) Camera module and the manufacturing process thereof

(75) Inventor: Chien-Lih Lung, Taipei (TW)

Correspondence Address: BACON & THOMAS, PLLC, 625 SLATERS LANE, FOURTH FLOOR, ALEXANDRIA, VA, 22314, US

(73) Assignee: PREMIER IMAGE TECHNOLOGY CORPORATION, Taipei (TW)

(21) Appl. No.: 11/253,638

(22) Filed: Oct. 20, 2005

(30) Foreign Application Priority Data
Mar. 2, 2005 (TW) 094106268

(51) Int. Cl. H04N 5/225; G02B 13/16

(52) U.S. Cl. 348/335; 348/340

(57) ABSTRACT

This invention provides a camera module and a manufacturing process thereof. The camera module is compatible with surface mount technology (SMT) machines for bonding onto a main board. The camera module comprises a lens, a lens holder, and an image sensor device. The lens and the lens holder are connected to each other, and the image sensor device is located under the lens holder. The lens is formed from a heatproof material for enduring the high-temperature process of an SMT soldering machine. The lens holder is also formed from a heatproof material for enduring the high-temperatures process of the SMT soldering machine. The camera module can thus be a surface mount device (SMD) to be bonded by SMT machines onto the main board of a system.

### BACKGROUND OF THE INVENTION

1. Field of the Invention

The present invention relates to a camera module, and more particularly, to a high heatproof camera module.

2. Description of the Related Art

A wide variety of audio and video information is now widely available in digital formats. An important device for the inputting and outputting of such information is the camera module. Because of its applicability in a broad array of fields, from small devices such as mobile phones, personal digital assistants (PDAs) to large devices such as large digital video cameras (including monitor systems), the digital camera module is becoming more and more useful.

Please refer to FIG. 1. When the traditional camera module 11 is assembled onto a main board 12 of a system, such as a mobile phone system, a laptop computer system, a digital camera system, or a digital video system, a socket 13 is usually required to connect the camera module 11 with the main board 12. Once the camera module 11 is electrically connected to the main board 12, the mobile phone, laptop computer, digital camera, or digital video camera, etc. is provided the functionality of a camera, and is able to provide static photographs, or even dynamic monitoring (such as a rear-view monitor for backing up a car).

However, the traditional camera module 11 is not heatproof, and so surface mount technology (SMT), which uses high-heat soldering equipment, cannot be used to assemble the camera module 11 with the main board 12. As a result, the traditional camera module 11 may be not provided for SMT assembly process and neither to achieve mass production.

### SUMMARY OF THE INVENTION

In order to resolve the above-mentioned problems, the present invention discloses a high heatproof camera module and a related manufacturing process thereof, which employs surface mount technology to directly bond the camera module onto a main board of a system.

The present invention provides a camera module comprising a lens, a lens holder, the lens and the lens holder engaged with each other, and an image sensor board located under the lens holder. The lens is formed from a highly heatproof material, preferably sustaining with more than 180° C.—the high temperature requirements of SMT soldering equipment. The highly heatproof material of the lens may be a ceramic, a highly heatproof glass, or the like. Additionally, because the lens holder of the present invention must also sustain with high temperature requirements of SMT soldering equipment, the lens holder is formed of a highly heatproof material, such as liquid crystal polymer (LCP), nylon, or the like. In addition, the image sensor board is typically made by SMT, so it can sustain the high temperatures of SMT soldering equipment.

The present invention also provides a manufacturing process for a camera module that comprises: providing a lens; engaging the lens with a lens holder; fixing an image sensor board onto a bottom of the holder; and combining the lens, the lens holder, and the image sensor board to form a surface mount device (SMD).

In one embodiment, before the step of forming the SMD, further comprises the step of adjusting the lens to substantially provide focus.

In another embodiment, the step of forming the SMD may further comprise the step of mounting solder balls on the SMD or applying solder on a surface of the SMD.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a conventional camera module.

FIG. 2 is an exploded view of a camera module according to the present invention.

FIG. 3 is a perspective view of the camera module of FIG. 2, where the camera module is to be mounted onto a main board.

FIG. 4 is a side view of the camera module and the main board of FIG. 3, where the camera module is mounted onto the main board.

FIG. 5 is a flow chart of a manufacturing process for the camera module according to the present invention.

### DETAILED DESCRIPTION OF THE PREFERRED EMBODIMENT

The following descriptions of the preferred embodiments are provided to help understand the features and structures of the present invention.

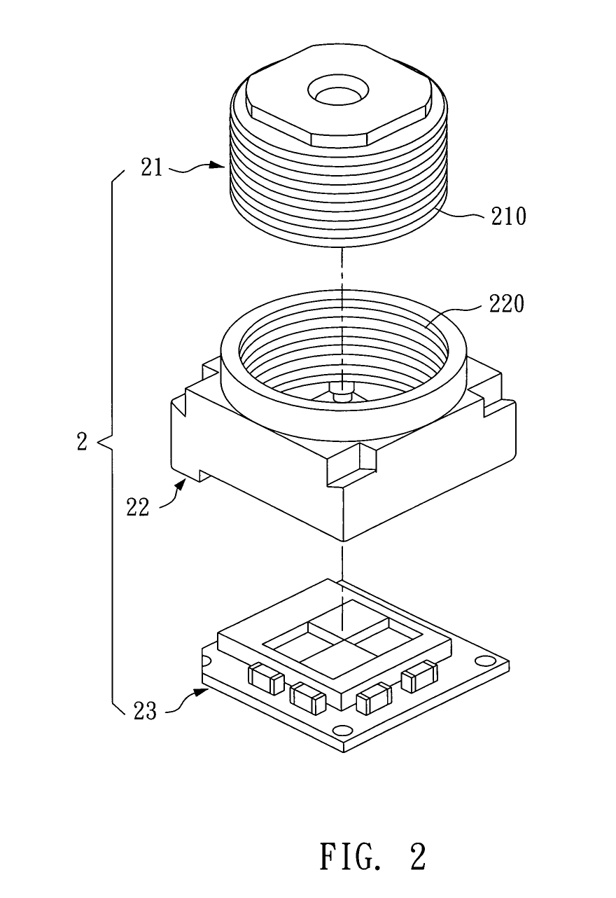

Please refer to FIG. 2, which shows an exploded view of a camera module 2 according to the present invention. The camera module 2 of this invention comprises a lens 21, a lens holder 22, and an image sensor board 23. The lens 21 and the lens holder 22 are engaged with each other. The image sensor board 23 is located under the lens holder 22 for the forming of an image. By adjusting the lens 21, the best focus of the camera module 2 can be reached.

In one exemplary embodiment, the engagement of the lens 21 and the holder 22 may be adapted by outer threads 210 of the lens 21 and inner threads 220 of the holder 22. Additionally, the engagement of the threads 210 and 220 can make the lens 21 movable; therefore, by moving the lens 21 to adjust the focus, the best focus of the camera module 2 can be reached.

The lens 21 of the present invention is formed of a highly heatproof material. In one exemplary embodiment of this invention, the highly heatproof material can sustain temperatures in excess of 180° C., such as the high temperatures of SMT soldering equipment (the typical temperature of soldering equipment is between about 180° C. and 240° C.). The material of the lens 21 may be, for example, ceramic, highly heatproof glass, or other such materials. Because the lens holder 22 of this invention is also required to sustain the high temperatures (i.e., in excess of 180° C.) of SMT soldering equipment, it is also formed from a highly heatproof material, such as liquid crystal polymer (LCP), nylon, or the like.

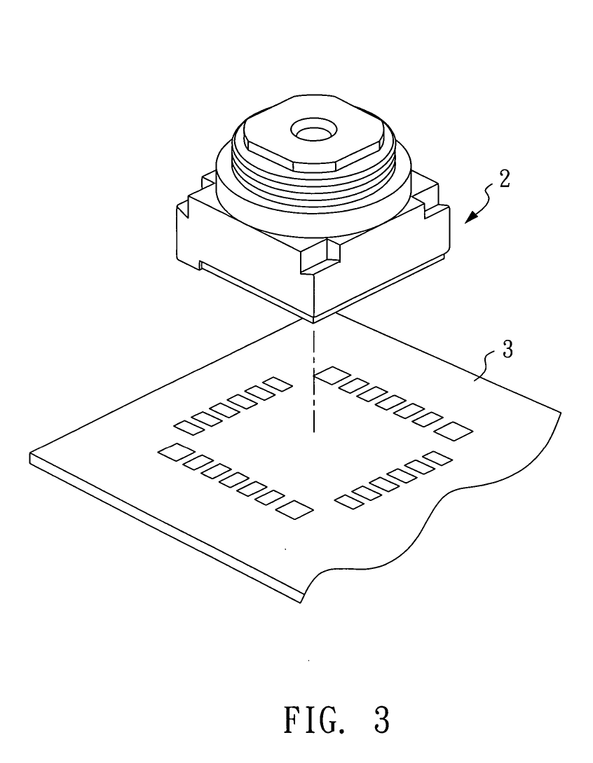

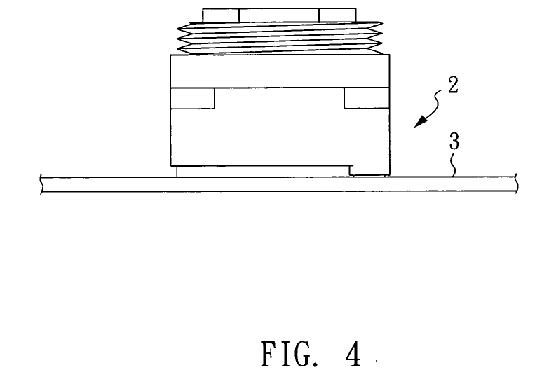

The lens 21 and the lens holder 22 are respectively formed from highly heatproof materials that are able to withstand the high temperatures of SMT soldering equipment. Normally, as known by those skilled in the art, the image sensor board 23 is made by SMT, so it is also able to sustain the high temperatures of SMT soldering equipment. The camera module 2 consequently is able to sustain the high temperatures of SMT soldering equipment. As shown in FIG. 3 and FIG. 4, the camera module 2, another embodiment of this invention, can be mounted onto a main board 3 of a system, such as a mobile phone system, a laptop computer system, a digital camera system, a digital video system, or the like. Thus, because of the electrical connection provided between the main board 3 and the camera module 2, the system (e.g. a mobile phone, a laptop computer, a digital camera, a digital video, etc.) is provided with camera-related functionalities. These functionalities include not only the static functions of still photography, but also dynamic monitoring, such as rear-view monitors for backing up a car.

The camera module 2 of this invention can sustain the high temperatures of SMT soldering equipment, enabling system manufacturers to bond the camera module 2 onto the main board 3 by surface mount technology, which thus enables production automation.

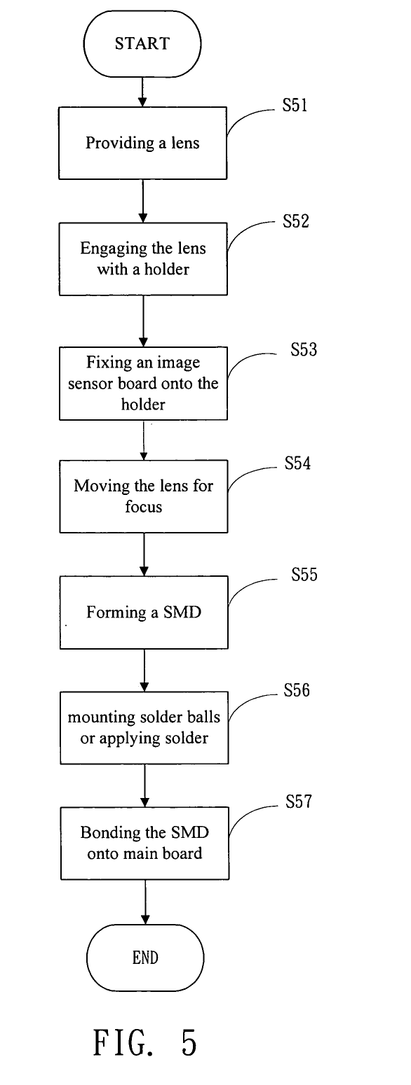

The manufacturing process for the camera module 2 according to this invention is described below. Referring to FIG. 2 and FIG. 5, after the block labeled “start”, step S51 provides a lens 21. Next, in step 52, the lens 21 is engaged with a lens holder 22, as described above, the engagement of the lens 21 and the lens holder 22 may be adapted by outer threads 210 of the lens 21 and inner threads 220 of the holder 22. In step S53, an image sensor board 3 is fixed onto a bottom of the lens holder 22.

In one embodiment, as required by system manufacturers, the lens 21 may need to be adjusted to pre-focused by a calibration tool, and thus the process of this invention also provides a step for the focusing of the lens 21, as shown in step S54. Preferably, the camera module 2 may be adjusted with a calibration tool to provide the appropriate focus by moving the lens 21 and the lens holder 22, and then stabilizing the best-focus position.

In step S55, a surface mount device (SMD) of the camera module 2 is formed by combining the lens 21, the lens holder 22, and the image sensor board 23. In step S57, the SMD of the camera module 2 can be adapted for bonding onto a main board 3 of a system, such as a mobile phone system, a laptop computer system, a digital camera system, a digital video system, or the like, with an SMT machine (not shown). Thus, because of the electrical connection provided between the main board 3 and the camera module 2, the system (e.g. a mobile phone, a laptop computer, a digital camera, a digital video, etc.) is provided with camera-related functions.

In one preferred embodiment, in order to bond the camera module 2 onto the main board 3, the step of forming the SMD may further comprise a step of mounting solder balls onto the SMD, or applying solder onto a surface of the SMD, as indicated in step S56. Finally, in step S57, the SMD of camera module 2 is bonded onto the main board 3 by surface mount technology.

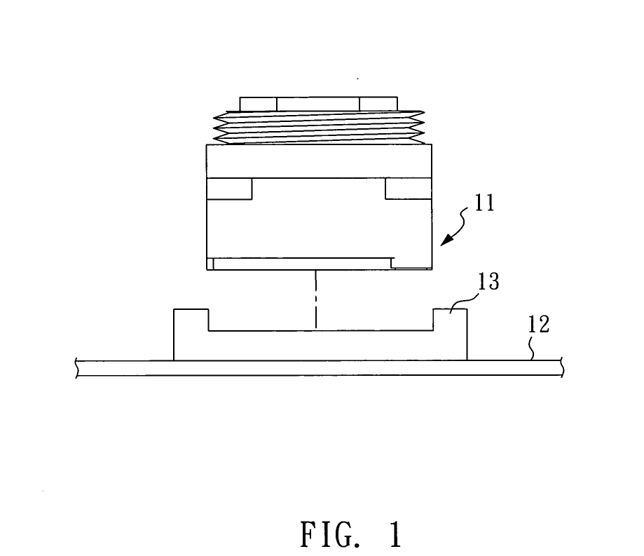

This invention may further comprise the step of packing the SMD of camera module 2, such as packing the SMD of camera module 2 in a tube or a roll, according to the SMT machine. Because this invention utilizes highly heatproof materials, it can be used in SMT machines for more efficient mass production. Additionally, the present invention can reduce costs associated with the socket 13, as depicted in FIG. 1, between the traditional camera module 11 and main board 12.

Although the present invention has been explained in relation to its preferred embodiment, it is to be understood that many other possible modifications and variations can be made without departing from the spirit and scope of the invention as hereinafter claimed.

What is claimed is:

1. A camera module comprising:
a lens formed of a highly heatproof material;
a lens holder engaged with the lens, the holder formed of a highly heatproof material; and
an image sensor board located under the lens holder.

2. The camera module of claim 1, wherein the lens and the lens holder are capable of sustaining temperatures in excess of 180° C.

3. The camera module of claim 1, wherein the highly heatproof material of the lens is chosen from a group consisting of highly heatproof glass and ceramic.

4. The camera module of claim 1, wherein the highly heatproof material of the lens holder is chosen from a group consisting of liquid crystal polymer and nylon.

5. The camera module of claim 1, wherein the camera module is capable of being bonded onto a main board of a system by surface mount technology (SMT).

6. The camera module of claim 5, wherein the system is chosen from a group consisting of a mobile phone system, a laptop computer system, a digital camera system, and a digital video system.

7. A process for manufacturing camera modules comprising:
providing a lens;
engaging the lens with a lens holder;
fixing an image sensor board onto a bottom of the holder; and
combining the lens, the lens holder, and the image sensor board to form a surface mount device.

8. The process of claim 7 further comprising a step of focusing the lens before forming the surface mount device.

9. The process of claim 7, wherein the step of forming the surface mount device further comprises mounting solder balls on the surface mount device.

10. The process of claim 7, wherein the step of forming the surface mount device further comprises applying solder on a surface of the surface mount device.

11. The process of claim 7, wherein the step of forming the surface mount device further comprises bonding the surface mount device onto a main board of a system.
